(19) United States
(12) Patent Application Publication
(10) Pub. No.: US 2026/0369303 A1
(43) Pub. Date: Nov. 19, 2026

(54) VIDEO PROCESSING DEVICE, VIDEO PROCESSING METHOD, AND PROGRAM

(71) Applicant: SONY GROUP CORPORATION, TOKYO (JP)

(72) Inventors: HISAKO SUGANO, TOKYO (JP); JUNICHI TANAKA, TOKYO (JP)

(21) Appl. No.: 19/158,781

(22) PCT Filed: Feb. 20, 2024
(86) PCT No.: PCT/JP2024/005925

§ 371 Date: Aug. 21, 2025

(30) Foreign Application Priority Data
Mar. 9, 2023 (JP) 2023-036165

(51) Int. Cl. G11B 27/036; G06V 10/25; G06V 10/26; G06V 10/77; G06V 20/40; G06V 40/16

(52) U.S. Cl. CPC G11B 27/036; G06V 10/267; G06V 10/77; G06V 20/46; G06V 20/49; G06V 40/161; G06V 40/168; G06V 10/25

(57) ABSTRACT

The present technique relates to a video processing device, a video processing method, and a program capable of suitably segmenting a region in which a performer appears, from a camera video.

A video processing device of the present technique includes an extraction unit that extracts, from a camera video obtained by photographing at least one of a plurality of persons, feature information indicating features of the person, a segmentation unit that segments a cropped video for each person from the camera video on the basis of the feature information, a recognition unit that recognizes the person appearing in the camera video, and an arrangement control unit that arranges a plurality of the cropped videos on the basis of a recognition result of the person. The present technique can be applied to, for example, a video processing system.

### TECHNICAL FIELD

The present technique relates to a video processing device, a video processing method, and a program, and particularly to a video processing device, a video processing method, and a program capable of suitably segmenting a region in which a performer appears, from a camera video.

### BACKGROUND ART

In recent years, the number of cases in which a huge display is installed behind a performer in a live venue where a live music performance is performed has increased. For example, a camera video obtained by photographing the performer is displayed on the display.

For example, in the case where a performance is performed by a group including a plurality of performers, since it is difficult to simultaneously photograph all the performers with one camera, one performer is photographed by each camera, and all the performers are photographed by a plurality of cameras. A synthetic video in which specific regions of the camera videos obtained by photographing each performer are segmented and arranged is displayed on the display.

### CITATION LIST

### Patent Literature

### PTL 1

PCT Patent Publication No. WO2018/173947

### SUMMARY

### Technical Problem

At present, it is not possible to change the range of a region segmented from a camera video in real time.

In the case where a performer is out of the region as a result of the fact that the performer moves or a camera operator cannot follow the movement of the performer, there is a possibility that a video without appearing of the face of the performer is displayed on a display.

Thus, while the video in which the performer himself/herself appears is displayed on the display, the performer stands at a designated position and cannot basically move from the position.

For example, PTL 1 describes a technique for segmenting a face region from a video of a monitoring camera. In a live music performance where a person (performer) appearing in a camera video can be identified, there is a need for a technique that can segment a desired region where the performer appears, from the camera video even if, for example, the performer moves.

The present technique has been developed in view of such a situation, and is capable of suitably segmenting a region in which a performer appears, from a camera video.

### Solution to Problem

A video processing device according to one aspect of the present technique includes: an extraction unit that extracts, from a camera video obtained by photographing at least one of a plurality of persons, feature information indicating features of the person; a segmentation unit that segments a cropped video for each person from the camera video on the basis of the feature information; a recognition unit that recognizes the person appearing in the camera video; and an arrangement control unit that arranges a plurality of the cropped videos on the basis of a recognition result of the person.

In a video processing method according to one aspect of the present technique, a video processing device extracts, from a camera video obtained by photographing at least one of a plurality of persons, feature information indicating features of the person, segments a cropped video for each person from the camera video on the basis of the feature information, recognizes the person appearing in the camera video, and arranges a plurality of the cropped videos on the basis of a recognition result of the person.

A program according to one aspect of the present technique causes a computer to execute processing of: extracting, from a camera video obtained by photographing at least one of a plurality of persons, feature information indicating features of the person; segmenting a cropped video for each person from the camera video on the basis of the feature information; recognizing the person appearing in the camera video; and arranging a plurality of the cropped videos on the basis of a recognition result of the person.

In one aspect of the present technique, from a camera video obtained by photographing at least one of a plurality of persons, feature information indicating features of the person is extracted, a cropped video for each person is segmented from the camera video on the basis of the feature information, the person appearing in the camera video is recognized, and a plurality of the cropped videos is arranged on the basis of a recognition result of the person.

### BRIEF DESCRIPTION OF DRAWINGS

FIG. 1 is a diagram for depicting a display example of a synthetic video.

FIG. 2 is a diagram for depicting an example of synthesizing videos of fixed segmented regions.

FIG. 3 is a diagram for depicting an example of synthesizing cropped videos segmented from camera videos by using the present technique.

FIG. 4 is a block diagram for depicting a configuration example of a video processing system.

FIG. 5 is a block diagram for depicting a functional configuration example of a video processing unit.

FIG. 6 is a diagram for depicting an example of feature points of a face.

FIG. 7 is a flowchart for explaining processing performed by the video processing unit.

FIG. 8 is a diagram for depicting another configuration example of the video processing system.

FIG. 9 is a block diagram for depicting another functional configuration example of the video processing unit.

FIG. 10 is a diagram for depicting an example of a plurality of camera videos and a synthetic video.

FIG. 11 is a diagram for depicting an example of a plurality of camera videos obtained by photographing the same performer.

FIG. 12 is a diagram for depicting an example of a face orientation.

FIG. 13 is a flowchart for explaining processing of selecting a cropped video according to the resolution and orientation of a subject.

FIG. 14 is a diagram for depicting an example of a stage.

FIG. 15 is a diagram for depicting another example of the stage.

FIG. 16 is a diagram for depicting an example of a synthetic video.

FIG. 17 is a diagram for depicting an example of tiling display.

FIG. 18 is a diagram for depicting an example of a synthetic video to which an effect of a member color is added.

FIG. 19 is a diagram for depicting an example of recognizing the face of a performer appearing in a camera video of a non-visible light camera.

FIG. 20 is a block diagram for depicting a configuration example of hardware of a computer.

### DESCRIPTION OF EMBODIMENT

Hereinafter, a mode for carrying out the present technique will be described. The description will be made in the following order.
1. Outline of the present technique
2. Basic configuration and operation of video processing system
3. Modified example

### 1. Outline of the Present Technique

In recent years, the number of cases in which a huge display is installed behind a performer in a live venue where a live music performance is performed has increased. For example, a camera video obtained by photographing the performer is displayed on the display.

The video displayed in the live venue is generated in a place called a video console. The video console is a place such as a video master control room (main adjustment room) where all the video signals are aggregated in the live venue.

A video server, a switcher, a router, and the like are arranged in the video console, and an operator in the video console selects a video signal to be output.

As an example, camera videos photographed by each of approximately ten camera operators arranged in the live venue are aggregated in the router of the video console, and effect processing and CG (Computer Graphics) synthesis are appropriately performed on these camera videos to generate a video (final video) to be finally presented. Then, the final video is displayed on the display installed in the live venue. It should be noted that processing for superimposing lyrics of music on the final video or the like is also performed in the video console.

For example, in the case where a performance is performed by a group including a plurality of performers, since it is difficult to simultaneously photograph all the performers with one camera, one performer is photographed by each camera, and all the performers are photographed by a plurality of cameras. The video server of the video console generates a synthetic video by segmenting and arranging specific regions of the camera videos obtained by photographing each performer.

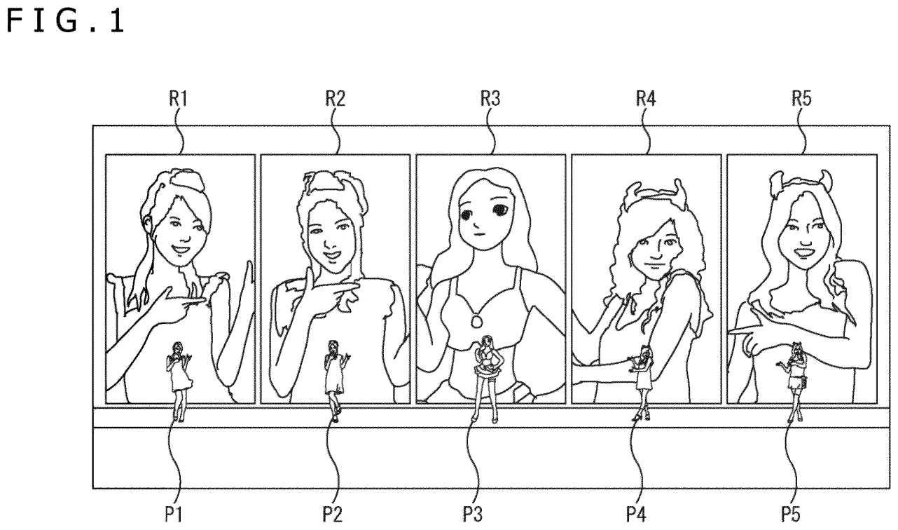

FIG. 1 is a diagram for depicting a display example of a synthetic video.

In the example of FIG. 1, a performance is performed by five performers P1 to P5 on a stage, and a synthetic video is displayed on a display installed behind the performers P1 to P5.

The synthetic video of FIG. 1 is divided into five regions R1 to R5 corresponding to the performers P1 to P5, respectively. The synthetic video is displayed in such a manner that the region R1 in which the performer P1 is displayed in a large size is arranged in a part behind the performer P1, the region R2 in which the performer P2 is displayed in a large size is arranged in a part behind the performer P2, and the region R3 in which the performer P3 is displayed in a large size is arranged in a part behind the performer P3. In addition, the synthetic video is displayed in such a manner that the region R4 in which the performer P4 is displayed in a larger size is arranged in a part behind the performer P4, and the region R5 in which the performer P5 is displayed in a large size is arranged in a part behind the performer P5.

When generating a synthetic video, the video server of the video console segments a fixed region in the camera video. The size (fixed ratio) of the segmented region, which is the region segmented from the camera video, is decided according to, for example, the number of pixels of the display.

Since the fixed segmented region is segmented, the camera operator needs to perform photographing such that, for example, the performer appears in the center of the camera video by being aware of the segmented region. Since the camera video is segmented at a fixed ratio, it is necessary for the camera operators to have a meeting with each other in advance about the size of the face of the performer on each camera video in order to make the sizes of the faces of the respective performers on the synthetic video uniform.

During a live music performance, the size of the face of the performer on each camera video is determined by the position and timing of the camera operator, and thus whether or not the sizes of the faces of the respective performers on the synthetic video are made uniform is left to the discretion of each camera operator. Thus, as the number of performers increases, the sizes of the faces of the respective performers on the synthetic video vary.

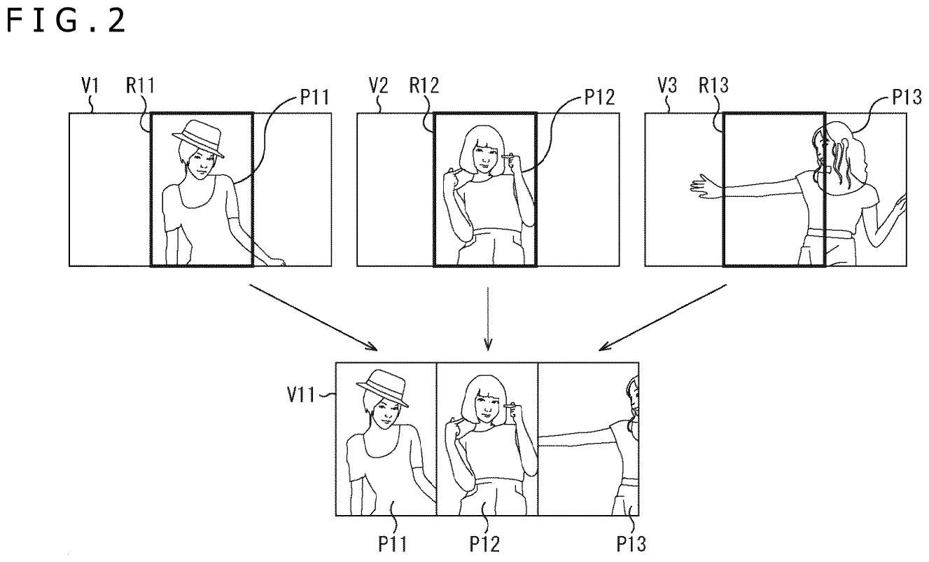

FIG. 2 is a diagram for depicting an example of synthesizing videos of the fixed segmented regions.

As depicted on the upper side of FIG. 2, camera videos V1 to V3 are videos obtained by photographing performers P11 to P13, respectively. The video server of the video console generates cropped videos by segmenting fixed segmented regions R11 to R13, which are surrounded by thick lines, from the camera videos V1 to V3. The video server of the video console generates a synthetic video V11 by arranging and synthesizing the cropped videos of the segmented regions R11 to R13.

At present, it is not possible to change the ranges of the segmented regions R11 to R13 in real time. In the case where the face of the performer P13 is out of the segmented region R13 as a result of the fact that the performer P13 moves or the cameraman cannot follow the movement of the performer P13, there is a possibility that the synthetic video V11 without appearing of the face of the performer P13 is displayed on the display of the live venue as depicted in the lower side of FIG. 2.

Thus, while the video in which the performer himself/herself appears is displayed on the display, the performer stands at a designated position and cannot basically move from the position.

For example, PTL 1 describes a technique for segmenting a face region from a video of a monitoring camera. In a live music performance etc. where a person (performer) appearing in a camera video can be identified, there is a need for a technique that can segment a desired region where the performer appears from the camera video even if the performer moves.

The present technique has been conceived by focusing on the above points, extracts feature information indicating features of a performer from a camera video obtained by photographing at least one of a plurality of performers (persons), segments a cropped video for each performer from the camera video on the basis of the feature information, recognizes the performer appearing in the camera video, and arranges a plurality of cropped videos on the basis of the recognition result of the performer, so that the region where the performer appears can be suitably segmented from the camera video.

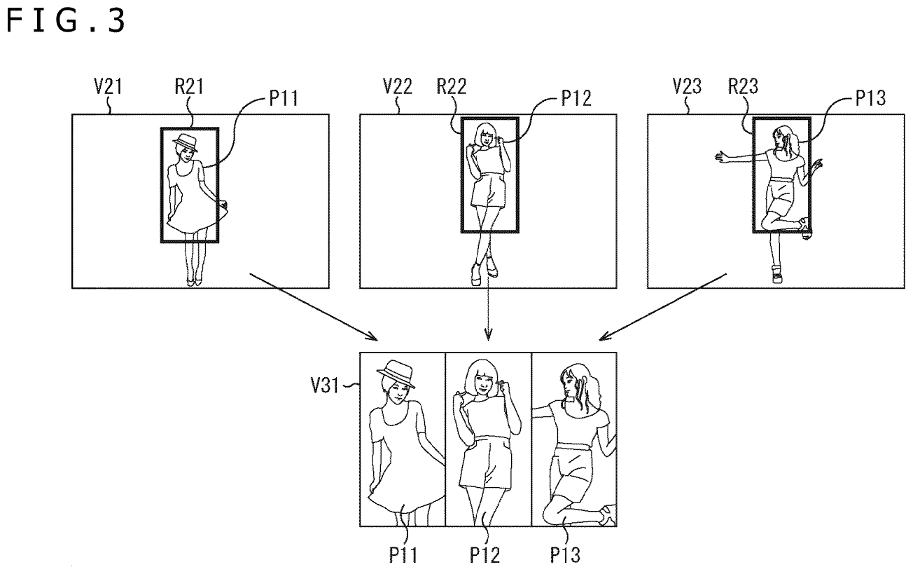

FIG. 3 is a diagram for depicting an example of synthesizing cropped videos segmented from camera videos by using the present technique.

As depicted on the upper side of FIG. 3, camera videos V21 to V23 are videos obtained by photographing the whole body of each of the performers P11 to P13 as subjects. The video server of the video console to which the present technique is applied extracts feature information indicating features of the subject from each of the camera videos V21 to V23, and adjusts the range (position and size) of the segmented region on the basis of the feature information of the subject. The feature information of the subject includes, for example, feature points of the face and position information of joints.

In the case where the feature points of the face are extracted from the camera video, the video server of the video console adjusts the range of the segmented region so that, for example, the segmented region includes all the feature points of the face and the centers of the faces of the respective performers are arranged side by side when the cropped videos are arranged. In the example of FIG. 3, segmented regions R11 to R13, which are surrounded by thick lines, are segmented from the camera videos V21 to V23 to generate cropped videos.

The video server of the video console generates a synthetic video V31 by arranging and synthesizing the cropped videos of the segmented regions R11 to R13. Since the ranges of the segmented regions R11 to R13 are adjusted such that the segmented regions R11 to R13 include all the feature points of the faces, the synthetic video V31 in which the faces of the performers P11 to P13 appear is displayed on the display of the live venue even if the performer P13 moves, as depicted on the lower side of FIG. 3.

As described above, the video server of the video console can adjust the segmented regions, segment the cropped videos, synthesize the cropped videos, and display the cropped videos in real time.

In the present technique, even if the performer moves from a designated position, the feature information of the performer is tracked in real time, so that the face or the like of the performer is not out of the segmented region. Thus, the performer can perform a performance in a free standing position. The camera operator does not need to closely follow the movement of the performer so that the face or the like of the performer is not out of the segmented region.

By adjusting the range of the segmented region on the basis of the feature information of each performer, it is possible to display a synthetic video in which the positions (heights) of the faces of the respective performers are made uniform on the display of the live venue, regardless of, for example, the heights of the performers. In addition, even if the sizes of the faces of the respective performers on the camera videos are different from each other, the sizes of the faces of the respective performers on the synthetic video can be made uniform.

It is possible to instantly switch from, for example, a synthetic video in which the whole body of each performer appears to a synthetic video in which the face of each performer appears in a large size by changing the conditions for adjusting the range of the segmented region.

### <2. Basic Configuration and Operation of Video Processing System

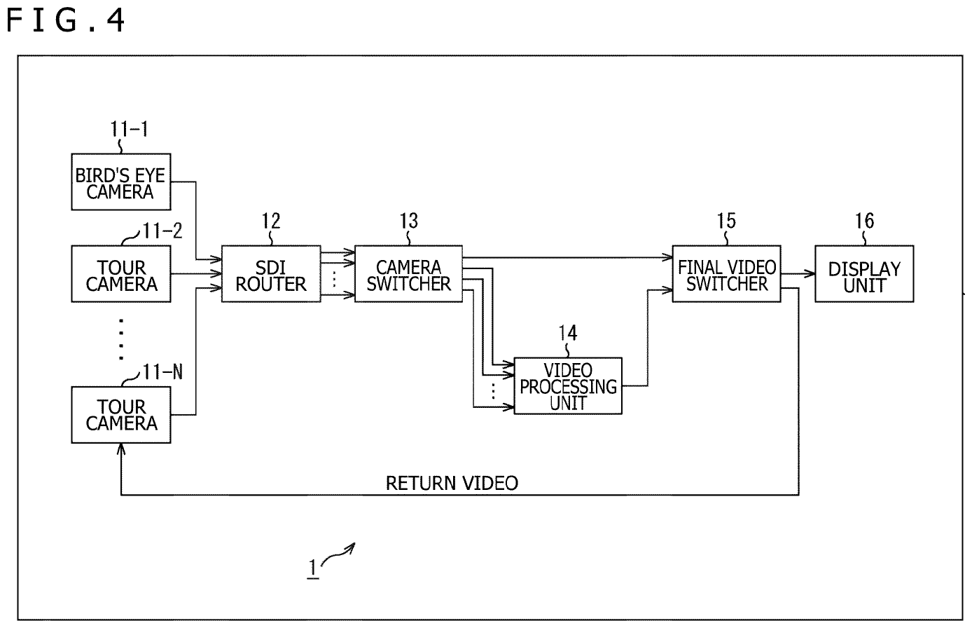

FIG. 4 is a block diagram for depicting a configuration example of a video processing system 1 that performs the above-described processing.

As depicted in FIG. 4, the video processing system 1 includes a bird's eye camera 11-1, tour cameras 11-2 to 11-N, an SDI (Serial Digital Interface) router 12, a camera switcher 13, a video processing unit 14, a final video switcher 15, and a display unit 16.

The bird's eye camera 11-1 is a camera arranged at a position that enables, for example, a bird's eye view of the whole live venue. The bird's eye camera 11-1 photographs the whole live venue as a subject, and Supplies the camera videos obtained as a result to the SDI router 12.

The tour cameras 11-2 to 11-N are arranged at, for example, fixed positions in the live venue, or move in the live venue together with the camera operators in the live venue. The tour cameras 11-2 to 11-N photograph at least a part of the inside of the live venue as a subject, and supplies the camera videos obtained as a result to the SDI router 12.

It should be noted that, in the case where there is no need to particularly distinguish the tour camera 11-2 to the tour camera 11-N from each other, they are also simply referred to as tour cameras 11 below.

As an example, photographing is performed using eight to ten tour cameras 11 in the live venue, but the number of tour cameras 11 may be any number.

In addition, in the case where there is no need to distinguish the bird's eye camera 11-1 from the tour cameras 11, they are also simply referred to as cameras 11 below. In the following, it is assumed that the camera videos photographed by the cameras 11 include at least one performer among a plurality of performers doing a performance on a stage or the like as a subject.

The SDI router 12 aggregates the camera videos photographed by all the cameras 11 in the live venue. The SDI router 12 supplies the camera videos supplied from each of the plurality of cameras 11 to the camera It should be noted that each camera 11 and the SDI router 12 may be connected to each other in a wired manner, in a wireless manner, or in a combination of the wired manner and the wireless manner.

The camera switcher 13 supplies any one or more camera videos among the plurality of camera videos supplied from the SDI router 12 to the video processing unit 14, and supplies any one or more camera videos among the plurality of camera videos supplied from the SDI router 12 to the final video switcher 15.

The video processing unit 14 generates a cropped video by segmenting a region where the performer appears in the camera videos supplied from the camera switcher 13, and generates a synthetic video by synthesizing a plurality of cropped videos. The video processing unit 14 supplies the synthetic video to the final video switcher 15. The video processing unit 14 corresponds to the video server of the video console.

The final video switcher 15 generates a final video on the basis of at least one of, for example, the camera videos supplied from the camera switcher 13, the synthetic video supplied from the video processing unit 14, a CG video prepared in advance, and lyric information, and supplies the final video to the display unit 16 to display it.

In addition, the final video switcher 15 supplies a return video to the camera 11 or a display device such as an SDI monitor or a tablet terminal arranged near the camera operator operating the camera 11 to display it. The return video is a video presented to the camera operator for confirmation of photographing timing and the like, and is generated by the final video switcher 15 by using the camera videos supplied from the camera switcher 13, the synthetic video supplied from the video processing unit 14, and the like.

It should be noted that the return video may be the same video as the final video presented to the audience or different from the final video. In addition, the return video may be a video different for each camera.

Each camera 11 or the display device corresponding to each camera 11 may be connected to the final video switcher 15 in a wired manner, in a wireless manner, or in a combination of the wired manner and the wireless manner.

For example, the SDI router 12, the camera switcher 13, the video processing unit 14, and the final video switcher 15 configuring the video processing system 1 are arranged in the video console.

The display unit 16 includes, for example, a display device such as an LED (Light Emitting Diode) vision or a liquid crystal panel, and is installed on a stage or the like in the live venue. The LED vision is a large display device including an LED panel. The display unit 16 displays the final video supplied from the final video switcher 15 to present the final video to the audience of the live performance.

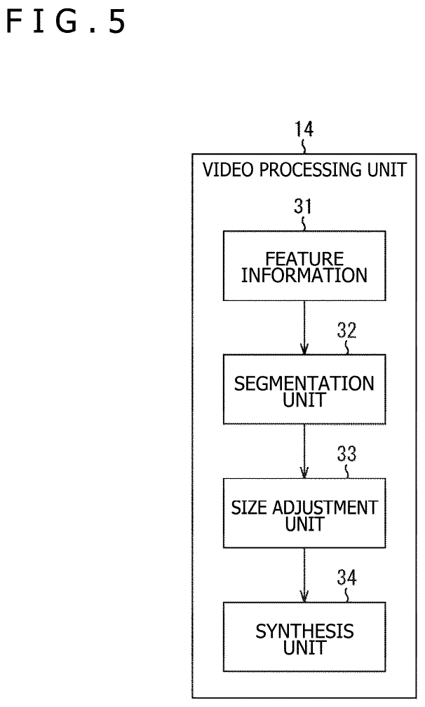

FIG. 5 is a block diagram for depicting a functional configuration example of the video processing unit 14.

As depicted in FIG. 5, the video processing unit 14 includes a feature information extraction unit 31, a segmentation unit 32, a size adjustment unit 33, and a synthesis unit 34.

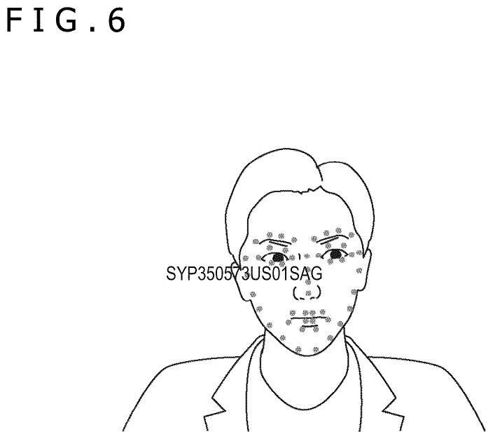

The feature information extraction unit 31 extracts feature information of the subject appearing in the camera video supplied from the camera switcher 13. As the feature information of the subject, position information of the joints of the performer, a bounding box surrounding the face of the performer, feature points of the face of the performer, and the like are extracted. As depicted by gray dots in FIG. 6, the feature points of the face indicate the positions of the eyebrows, eyes, a nose, a mouth, contours, and the like.

The feature information extraction unit 31 supplies the feature information of the subject, and the camera video to the segmentation unit 32.

On the basis of the feature information extracted by the feature information extraction unit 31, the segmentation unit 32 segments a region in the camera video where the performer appears, to generate a cropped video, and supplies the feature information of the subject, and the cropped video to the size adjustment unit 33.

The size adjustment unit 33 adjusts the size of the cropped video on the basis of the size of the subject on the cropped video supplied from the segmentation unit 32. The size of the subject on the cropped video is identified on the basis of, for example, the feature information of the subject.

Since the size of the performer on the cropped video changes depending on the standing position of the performer as the subject and the size of the performer on the camera video, if the cropped video is synthesized without adjusting the size of the cropped video, there is a possibility that a synthetic video in which a plurality of performers with different sizes is arranged is generated.

In the case where the bounding box of the face is extracted as the feature information of the subject, the size adjustment unit 33 adjusts the sizes of the respective cropped videos so that the sizes of the bounding boxes on the cropped videos are the same. In the case where the feature points of the eyes are extracted as the feature information of the subject, the size adjustment unit 33 adjusts the sizes of the respective cropped videos so that the distances between both eyes on the cropped videos are the same. It should be noted that the sizes of the cropped videos may be adjusted on the basis of either the bounding box of the face or the feature points of the eyes, or the sizes of the cropped videos may be adjusted on the basis of both the bounding box of the face and the feature points of the eyes.

The size adjustment unit 33 supplies the cropped videos with the sizes adjusted to the synthesis unit 34.

The synthesis unit 34 generates a synthetic video by, for example, arranging the cropped videos supplied from the size adjustment unit 33 side by side and synthesizing them. The synthesis unit 34 may enlarge or reduce the synthetic video according to the size and aspect ratio of the display unit 16, or may crop the synthetic video according to the size and aspect ratio of the display unit 16.

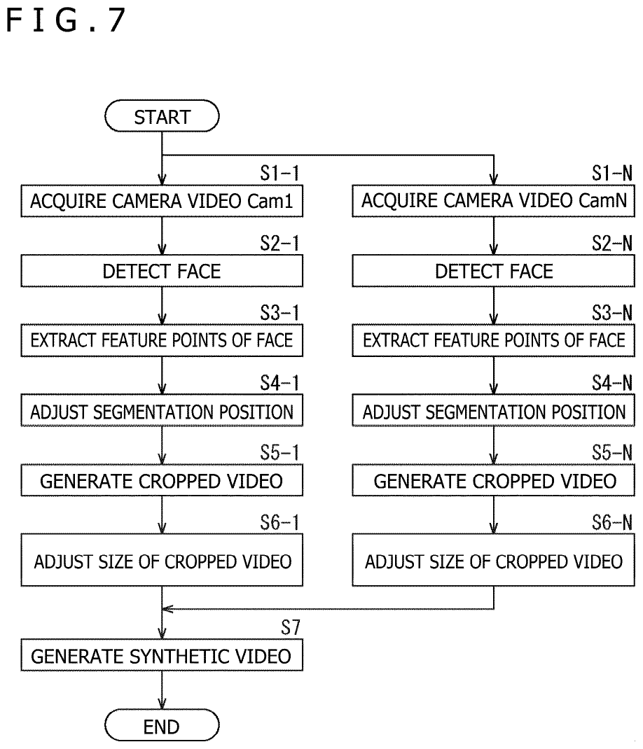

Next, processing performed by the video processing unit 14 having the configuration as described above will be described with reference to a flowchart of FIG. 7. In the following, an example in which the feature information extraction unit 31 extracts feature points of a face as feature information of a subject will be described.

In Step S1-1, the feature information extraction unit 31 acquires a camera video Cam1 photographed by a certain camera 11.

In Step S2-1, the feature information extraction unit 31 detects a face appearing in the camera video Cam1.

In Step S3-1, the feature information extraction unit 31 extracts feature points of the face from the camera video Cam1.

In Step S4-1, the segmentation unit 32 adjusts the position of the segmented region on the basis of the feature points of the face.

The segmentation unit 32 adjusts the position of the segmented region such that, for example, the feature points of the eyes are arranged side by side when the cropped videos are arranged side by side. It should be noted that, in the case where the bounding box of the face is extracted as the feature information of the subject, the segmentation unit 32 adjusts the position of the segmented region so that, for example, the centers of the bounding boxes are at the same position (height) when the cropped videos are arranged side by side.

In Step S5-1, the segmentation unit 32 segments a region in the camera video Cam1 where the performer appears, and generates a cropped video.

In Step S6-1, the size adjustment unit 33 adjusts the size of the cropped video segmented from the camera video Cam1.

Steps S1-N to S6-N are executed in parallel with the processing of Steps S1-1 to S6-1.

In Step S1-N, the feature information extraction unit 31 acquires a camera video CamN photographed by another camera 11.

In Step S2-N, the feature information extraction unit 31 detects a face appearing in the camera video CamN.

In Step S3-N, the feature information extraction unit 31 extracts feature points of the face from the camera video CamN.

In Step S4-N, the segmentation unit 32 adjusts the position of the segmented region on the basis of the feature points of the face.

In Step S5-N, the segmentation unit 32 segments a region in the camera video CamN where the performer appears, and generates a cropped video.

In Step S6-N, the size adjustment unit 33 adjusts the size of the cropped video segmented from the camera video CamN.

After the sizes of the cropped videos are adjusted in Steps S6-1 and S6-N, the processing proceeds to Step S7. In Step S7, the synthesis unit 34 generates a synthetic video by arranging side by side the cropped video segmented from the camera video Cam1 and the cropped video segmented from the camera video CamN and synthesizing them.

It should be noted that, in FIG. 7, an example in which the cropped videos are segmented and synthesized from the two camera videos of the camera video Cam1 and the camera video CamN has been described, but in practice, the video processing unit 14 can segment and synthesize cropped videos from a given number of camera videos.

As described above, in the video processing unit 14 of the present technique, since the segmented region is adjusted on the basis of the feature information of the subject, the region where the performer appears can be segmented if the performer appears in the camera video.

Thus, the performer can perform a performance at a free standing position, and the camera operator does not need to closely follow the movement of the performer.

It should be noted that the above processing is executed in real time because a video direction in a live venue is assumed. The present technique can also be applied to, for example, generation of offline content, and in this case, the above processing need not be executed in real time.

### 3. Modified Example

Example in which cropped videos in which the same person appears are not synthesized When a performance is performed by a plurality of members (performers), the same performer is photographed by a plurality of cameras in some cases. At present, in order not to synthesize cropped videos in which the same performer appears, cropped videos are segmented from designated camera videos for each performer, or fixed segmented regions are segmented while the performer stands at a designated position.

In the video processing system 1 of the present technique, it is possible not to synthesize cropped videos in which the same person appears by causing a recognizer to learn in advance feature information of members that can appear in camera videos and causing the recognizer to recognize the persons appearing in the camera videos. The recognizer recognizes, for example, the face of the member.

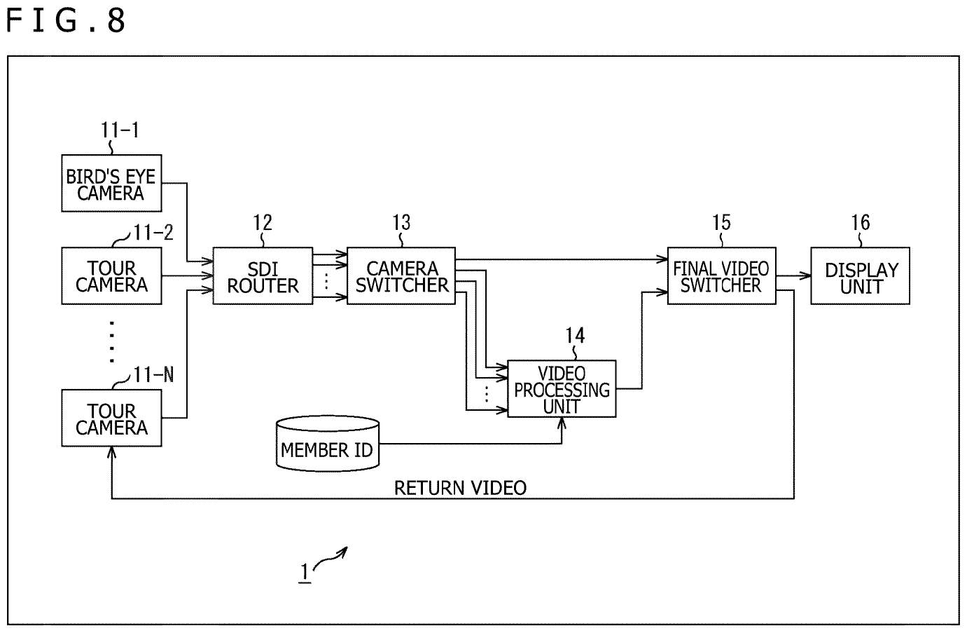

FIG. 8 is a block diagram for depicting another configuration example of the video processing system 1. In FIG. 8, the same configurations as those in FIG. 4 are denoted by the same reference numerals. Duplicated explanations will be appropriately omitted.

The video processing system 1 of FIG. 8 differs from the video processing system 1 of FIG. 4 in that the video processing unit 14 acquires member IDs.

The video processing unit 14 has a recognizer that has learned in advance feature information of the face of each member with the member ID assigned. For example, when a camera video is input, the recognizer outputs the member ID assigned to a person appearing in the camera video. The video processing unit 14 can identify the member appearing in the camera video on the basis of the member ID output from the recognizer.

It should be noted that the camera video supplied to the video processing unit 14 may be a video obtained by photographing one member or a video obtained by simultaneously photographing a plurality of members.

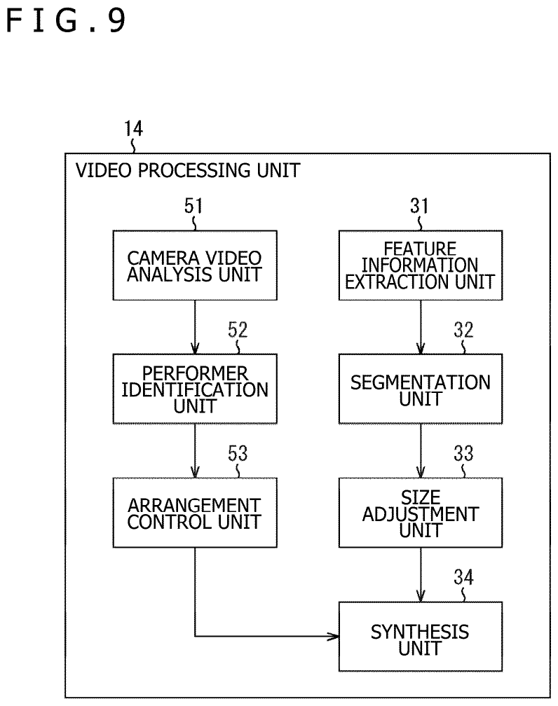

FIG. 9 is a block diagram for depicting another functional configuration example of the video processing unit 14. In FIG. 9, the same configurations as those in FIG. 5 are denoted by the same reference numerals. Duplicated explanations will be appropriately omitted.

The video processing unit 14 of FIG. 9 differs from the video processing unit 14 of FIG. 5 in that a camera video analysis unit 51, a performer identification unit 52, and an arrangement control unit 53 are provided.

The camera video analysis unit 51 analyzes a plurality of camera videos and identifies, for example, a camera video obtained by photographing the same performer (member). The camera video analysis unit 51 supplies the analysis result of each camera video and the plurality of camera videos to the performer identification unit 52.

The performer identification unit 52 inputs the camera videos supplied from the camera video analysis unit 51 to the above-described recognizer and acquires the member ID assigned to the member appearing in each camera video. The performer identification unit 52 functions as a recognition unit for recognizing a person appearing in a camera video by using the recognizer. The performer identification unit 52 supplies information indicating the member ID of the member appearing in each camera video and the analysis result by the camera video analysis unit 51 to the arrangement control unit 53.

It should be noted that the identification of the camera video obtained by photographing the same member, which is performed by the camera video analysis unit 51, may also be performed by the recognizer.

The arrangement control unit 53 arranges cropped videos on a two-dimensional plane on the basis of the analysis result by the camera video analysis unit 51 and the member ID of the member identified by the performer identification unit 52 and appearing in each camera video.

Specifically, the arrangement control unit 53 arranges the cropped videos side by side on a two-dimensional plane to cause the synthesis unit 34 to generate a synthetic video. In addition, in the case where an individual cropped video is displayed on each of a plurality of display units 16, the arrangement control unit 53 controls which cropped video to be arranged on each of the plurality of display units 16.

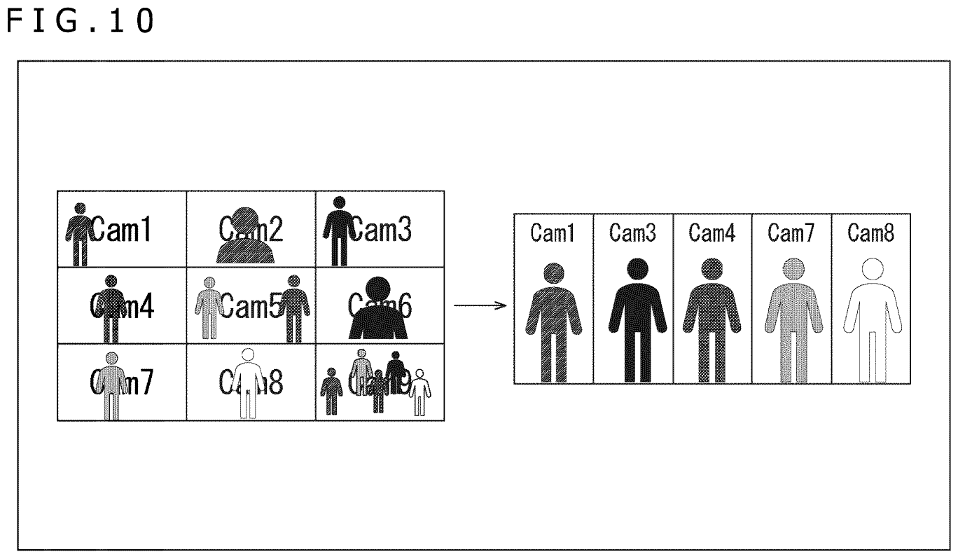

FIG. 10 is a diagram for depicting an example of a plurality of camera videos and a synthetic video.

As depicted on the left side of FIG. 10, it is assumed that, for example, nine camera videos Cam1 to Cam9 have been photographed. In the example of FIG. 10, the camera videos Cam1 and Cam2 are videos obtained by photographing the same member, and the camera videos Cam3 and Cam6 are videos obtained by photographing the same member. The camera video Cam5 is a video obtained by photographing two members each appearing in the camera videos Cam4 and Cam7, and the camera video Cam9 is a video obtained by photographing five members each appearing in the camera videos Cam1, Cam3, Cam4, Cam7, and Cam8.

The camera video analysis unit 51 analyzes the camera videos Cam1 to Cam9, and identifies that, for example, the camera videos Cam1, Cam2, and Cam9 are videos obtained by photographing the same member. The performer identification unit 52 acquires, for example, the member ID of the member appearing in the camera videos Cam1 and Cam2 (and Cam9).

As depicted on the right side of FIG. 10, for example, the arrangement control unit 53 arranges side by side cropped videos segmented from the camera video Cam1, the camera video Cam3, the camera video Cam4, the camera video Cam7, and the camera video Cam8 in the order from the left.

Since the members appearing in the respective camera videos are identified, the video processing unit 14 can synthesize the five cropped videos in which the respective five members appear, and it is possible not to synthesize the cropped videos in which the same person appears. In addition, the arrangement control unit 53 can arrange the respective cropped videos in the positions (in order) assigned to the members appearing in the cropped videos. It should be noted that the arrangement order of the respective members on the stage may be identified on the basis of camera videos photographed by the bird's eye camera 11-1, and the cropped videos may be arranged so as to correspond to the arrangement order of the respective members on the stage.

As described above, by recognizing the person appearing in the camera videos, it is possible not to synthesize the cropped videos in which the same person appears even if cropped videos are not segmented from designated camera videos for each performer or the performer does not stand at the designated position.

For example, the camera 11 may suddenly break down during a live performance. In the case where cropped videos are segmented from designated camera videos, it is necessary to designate again the camera number of the camera videos from which the cropped videos are segmented. In the present technique, for example, in the case where the video signal of the camera video Cam3 stops, it is possible to segment cropped videos from the camera video Cam6 or the camera video Cam9 without designating the camera number.

Since the camera videos (cropped videos) to be synthesized becomes fluid, the camera operator does not need to continuously photograph a designated member, and the burden on the camera operator can be reduced.

In the case where the person appearing in the camera video is not recognized, at least the number of cameras 11 corresponding to the number of members has been required to photograph one member with one camera. By recognizing the person appearing in the camera video, the cropped video in which each member appears is segmented from the camera video in which a plurality of members appear, so that the cropped videos in which all the members appear can be obtained.

Thus, even if a plurality of members is photographed by one camera 11, the cropped videos in which all the members appear can be obtained. For example, in the case where a performance is performed by seven performers, if four members are photographed by one camera 11, a synthetic video in which seven cropped videos in which the seven members appear are arranged can be generated by synthesizing two camera videos.

In addition, by recognizing the person appearing in the camera video, it is possible to generate a synthetic video in which the cropped videos in which the respective members appear are arranged in the desired order even if, for example, the arrangement order of the members on the stage changes.

### Example in Which a Cropped Video is Selected According to the Resolution and Orientation of a Subject

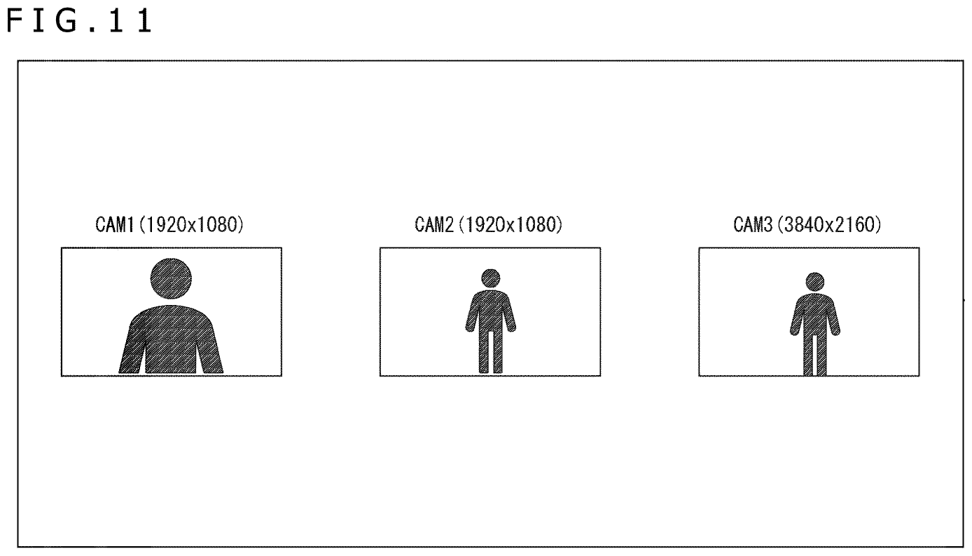

FIG. 11 is a diagram for depicting an example of a plurality of camera videos obtained by photographing the same performer.

As depicted in FIG. 11, when a performance is performed by a plurality of members (performers), the same performer is photographed by a plurality of cameras in some cases. A camera video Cam1 depicted on the left side of FIG. 11 is a video obtained by photographing a part above the chest of the performer with a resolution of 1920×1080, and a camera video Cam2 depicted in the center of FIG. 11 is a video obtained by photographing the whole body of the performer with a resolution of 1920×1080. A camera video Cam3 depicted on the right side of FIG. 11 is a video obtained by photographing the whole body of the performer with a resolution of 3840×2160.

Since it is preferable that the face of a performer is finely displayed in a large size, for example, the video processing unit 14 compares the resolutions of the face regions, which are regions in the cropped videos where the face of the performer appears, and adopts a cropped video having the largest resolution of the face region as the cropped video to be synthesized.

In the example of FIG. 11, the resolution of the face region of the camera video Cam1 is larger than the resolution of the face region of the camera video Cam2. Similarly, the resolution of the face region of the camera video Cam1 is compared with the resolution of the face region of the camera video Cam3, and the camera video having the larger resolution of the face region is synthesized to generate a synthetic video.

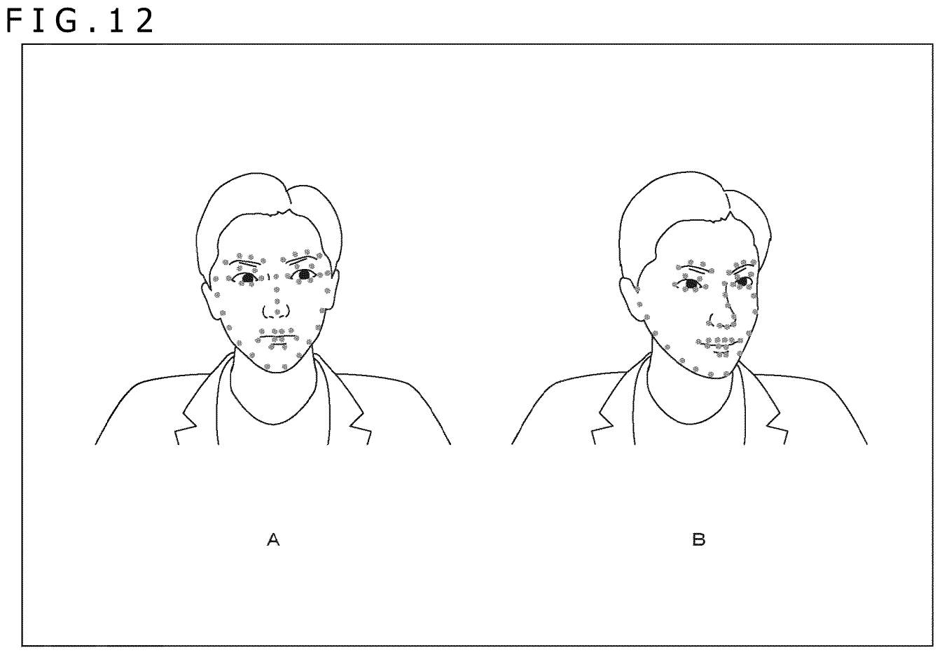

FIG. 12 is a diagram for depicting an example of a face orientation.

A of FIG. 12 depicts feature points of the face of a performer facing the front, and B of FIG. 12 depicts feature points of the face of the performer facing the left side as viewed from the performer. The video processing unit 14 can identify, for example, the direction of the face of the performer appearing in the camera video on the basis of the feature points of the face.

Since it is preferable to display a video in which the whole body and the face of a performer face the front, the video processing unit 14 adopts, for example, a cropped video in which the face of the performer faces the front as the cropped video to be synthesized as depicted in A in FIG. 12.

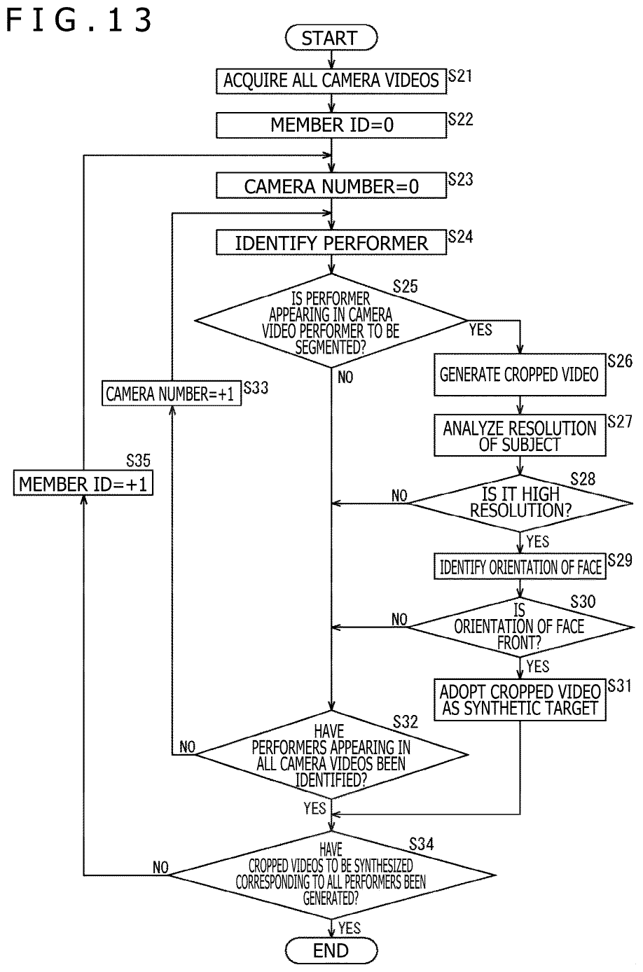

Processing of selecting a cropped video according to the resolution and orientation of a subject will be described with reference to a flowchart in FIG. 13. The processing of FIG. 13 corresponds to the processing in Step S5-1 or Step S5-N in FIG. 7, and is executed by, for example, the video processing unit 14 having the configuration of FIG. 9.

In Step S21, the video processing unit 14 acquires all camera videos.

In Step S22, the arrangement control unit 53 sets a value of 0 as the member ID of a member to be segmented.

In the following, a cropped video in which the member to be segmented appears is segmented from the camera video.

In Step S23, the arrangement control unit 53 sets a value of 0 as the camera number of the camera video to be processed.

In Step S24, the performer identification unit 52 identifies a member (performer) appearing in the camera video to be processed, and acquires the member ID of the member.

In Step S25, the arrangement control unit 53 determines whether or not the member appearing in the camera video is the member to be segmented. For example, in the case where the member ID of the member appearing in the camera video matches the member ID of the member to be segmented, it is determined that the member appearing in the camera video is the member to be segmented.

In the case where it is determined in Step S25 that the member appearing in the camera video is the member to be segmented, the processing proceeds to Step S26. In Step S26, the segmentation unit 32 segments a region in which the member to be segmented appears, from the camera video to be processed, and generates a cropped video.

In Step S27, the camera video analysis unit 51 analyzes the resolution of a subject region in the cropped video that is a region in which the subject appears. For example, the resolution of the face region in the cropped video is analyzed. It should be noted that the resolution of the subject region may be analyzed after the cropped video is segmented or before the cropped video is segmented.

In Step S28, the arrangement control unit 53 determines whether or not the subject region has a high resolution. For example, in the case where the resolution of the subject region is higher than a predetermined threshold value, it is determined that the subject region has a high resolution.

It should be noted that whether or not the subject region has a high resolution may be determined on the basis of the degree of blur of the subject region, or may be determined on the basis of the amount of feature points of the face occupied in the cropped video or the pixel positions of the feature points of the face. In addition whether or not the subject region has a high resolution may be determined on the basis of the size of the bounding box surrounding the face, or may be determined on the basis of the resolution obtained by resolution measurement.

In the case where it is determined in Step S28 that the subject region has a high resolution, the processing proceeds to Step S29. In Step S29, the arrangement control unit 53 identifies the orientation of the face of the member appearing in the cropped video. It should be noted that the orientation of the face of the member may be identified on the basis of the homography of the feature points of the face, or may be identified by visual line detection such as detecting, for example, whether the member is looking at the camera. In addition, the orientation of the face of the member may be identified on the basis of the rotation angle of the face output by a face detection library.

In Step S30, it is determined whether or not the orientation of the face of the member is the front.

In the case where it is determined in Step S30 that the orientation of the face is the front, the processing proceeds to Step S31. In Step S31, the arrangement control unit 53 adopts the cropped video segmented from the camera video to be processed as the cropped video to be synthesized.

In the case where an evaluation point based on the resolution of the subject region and the orientation of the face of the member is higher than a predetermined threshold value, the cropped video segmented from the camera video to be processed may be adopted as the cropped video to be synthesized.

For example, in the case where the face of the member faces sideways even if the subject region has a high resolution, the evaluation point becomes low. Similarly, in the case where the face of the member faces the front and the subject region has a low resolution, the evaluation point becomes low. Although it cannot be unconditionally evaluated because it is preferable to display a profile depending on dances or songs, for example, the arrangement control unit 53 holds an evaluation function as a parameter, and can select a cropped video to be synthesized on the basis of the evaluation point calculated by using the evaluation function.

It should be noted that an operator in the video console may select a desired cropped video from candidates by using a switch.

On the other hand, in the case where it is determined in Step S25 that the member appearing in the camera video is not the member to be segmented, the cropped video to be segmented from the camera video to be processed is not adopted as the cropped video to be synthesized. Similarly, in the case where it is determined in Step S28 that the subject region has a low resolution, or in the case where it is determined in Step S30 that the orientation of the face is not the front, the cropped video to be segmented from the camera video to be processed is not adopted as the cropped video to be synthesized.

In the case where the cropped video segmented from the camera video to be processed is not adopted as the cropped video to be synthesized, the processing proceeds to Step S32. In Step S32, the arrangement control unit 53 determines whether or not the members appearing in all the camera videos have been identified.

In the case where it is determined in Step S32 that the members appearing in all the camera videos have not been identified, the processing proceeds to Step S33. In Step S33, the arrangement control unit 53 increments the camera number of the camera video to be processed by 1. Thereafter, the processing returns to Step S24, and subsequent processing is performed. That is, it is determined whether or not a cropped video segmented from a camera video other than the camera video to be processed can be adopted as the cropped video to be synthesized.

In the case where it is determined in Step S32 that the members appearing in all the camera videos have been identified, or after the processing of Step S31 is performed, the processing proceeds to Step S34. In Step S34, the arrangement control unit 35 determines whether or not cropped videos to be synthesized corresponding to all the members (in which the respective members appear) have been generated.

In the case where it is determined in Step S34 that cropped videos to be synthesized corresponding to all the members have not been generated, the processing proceeds to Step S35. In Step S35, the arrangement control unit 35 increments the member ID of the member to be segmented by 1. Thereafter, the processing returns to Step S23, and subsequent processing is performed. That is, cropped videos to be synthesized corresponding to members other than the member to be segmented are generated.

On the other hand, in the case where it is determined in Step S34 that cropped videos to be synthesized corresponding to all the members have been generated, the processing is terminated.

As described above, the video processing unit 14 of the present technique can automatically select the highest quality cropped video and can output a high quality synthetic video. In addition, the video processing unit 14 can automatically select the most suitable cropped video for a video direction of a live performance in consideration of the whole bodies and the orientations of the faces of the members on the cropped videos.

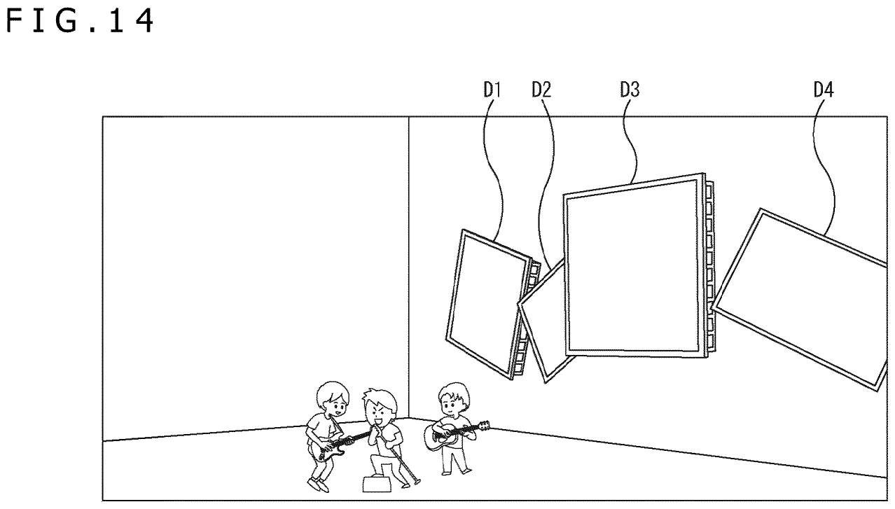

### Example in Which the Size of a Cropped Region is Adjusted According to the Size and the Number of Pixels of the Display Unit 16 FIG. 14 is a diagram for depicting an example of a stage.

As depicted in FIG. 14, the display units 16 that are different from each other in the size, aspect ratio, and number of pixels, such as displays D1 to D4 are installed on the stage in some cases. Each of the displays D1 to D4 displays, for example, a cropped video in which each member doing a performance on the stage appears in a large size without being synthesized.

The video processing unit 14 of the present technique segments each cropped video such that, for example, the sizes of the faces of the respective members on the cropped videos displayed on the displays D1 to D4 are the same.

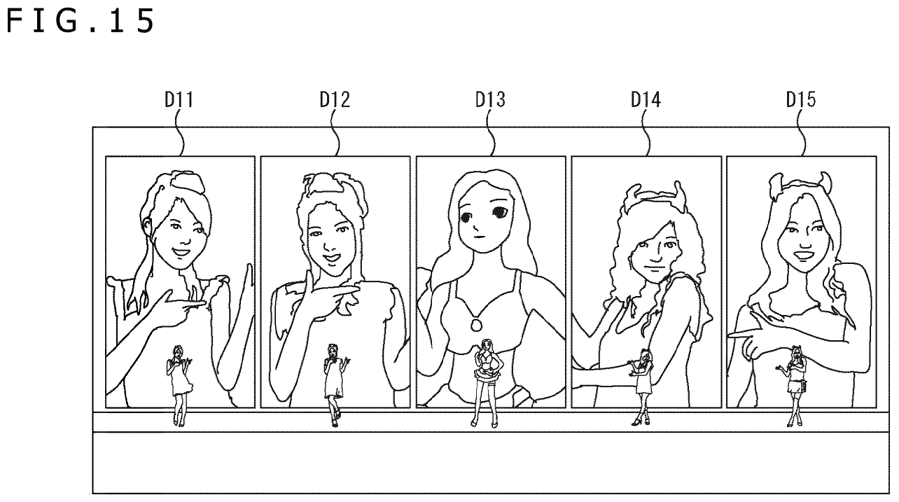

FIG. 15 is a diagram for depicting another example of the stage.

Displays D11 to D15 that can be individually moved are installed on the stage in some cases. In the example of FIG. 15, each of the displays D11 to D15 can be moved in the lateral direction of the stage. Each of the displays D11 to D15 displays, for example, a cropped video in which each performer doing a performance on the stage appears in a large size without being synthesized.

The video processing unit 14 of the present technique can adjust the ranges (the positions, sizes, aspect ratios, shapes, and the like) of the segmented regions on the basis of the sizes, aspect ratios, and resolutions of the display units 16 on which the cropped videos (synthetic video) are displayed. Accordingly, even in the case where a plurality of display units 16 that are different from each other in the size, aspect ratio, and resolution is installed on one stage, the cropped video for each display unit 16 can be segmented from the camera video.

### Example in Which the Range of a Segmented Region is Adjusted According to an Individual Singing Part

In the case where a song is sung by a plurality of members, an individual singing part (person in charge of singing each bar) is determined. The video processing unit 14 of the present technique may change a member to be segmented according to the individual singing part.

For example, among the members on the stage, cropped videos in which the respective members who are singing a song appear are synthesized and displayed.

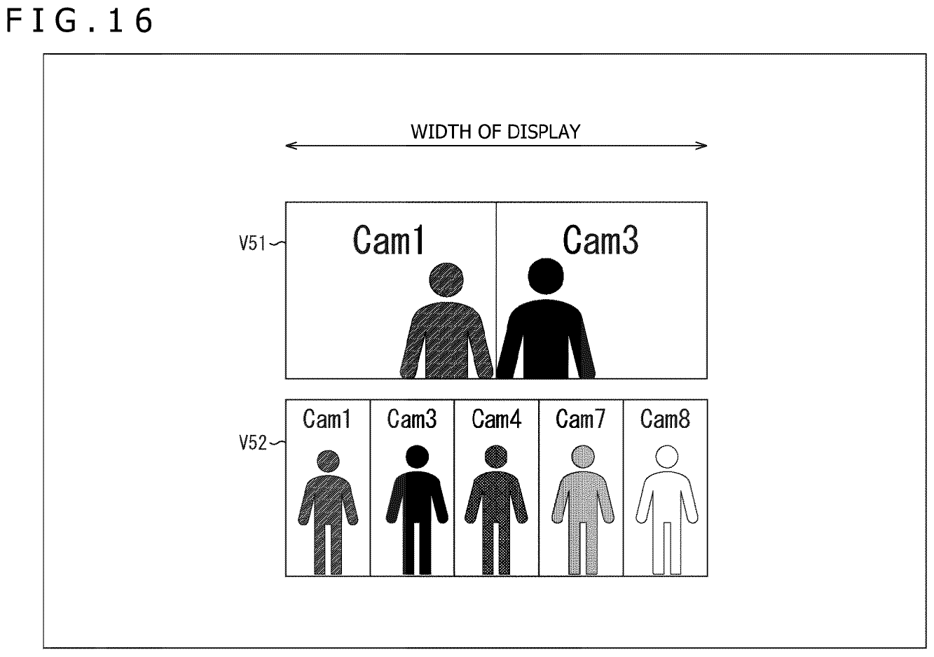

FIG. 16 is a diagram for depicting an example of a synthetic video.

As depicted in FIG. 16, for example, the number of members appearing on a synthetic video varies in some cases, such as a case where, in a certain period, a synthetic video V51 in which two members appear is displayed and, in another period, a synthetic video V52 in which five members appear is displayed.

Since the size, aspect ratio, and number of pixels of the display unit 16 are fixed, the video processing unit 14 identifies the member to be segmented according to the individual singing part, and adjusts the range of the segmented region according to the number of members to be segmented (the number of cropped videos displayed on the display unit 16), the width of the display unit 16, and the like.

In the example of FIG. 16, in the case where two members appear in the synthetic video, the cropped videos are segmented such that the two members appear near the center of the synthetic video and the upper bodies of the two members appear in the synthetic video. In addition, in the case where five members appear in the synthetic video, the cropped videos are segmented such that each member appears near the center of the cropped video and the whole bodies of the five members appear in the synthetic video.

By adjusting the range of the segmented region according to the individual singing part, the video processing unit 14 can segment the cropped video such that, for example, the face of the performer maximally appears in a large size.

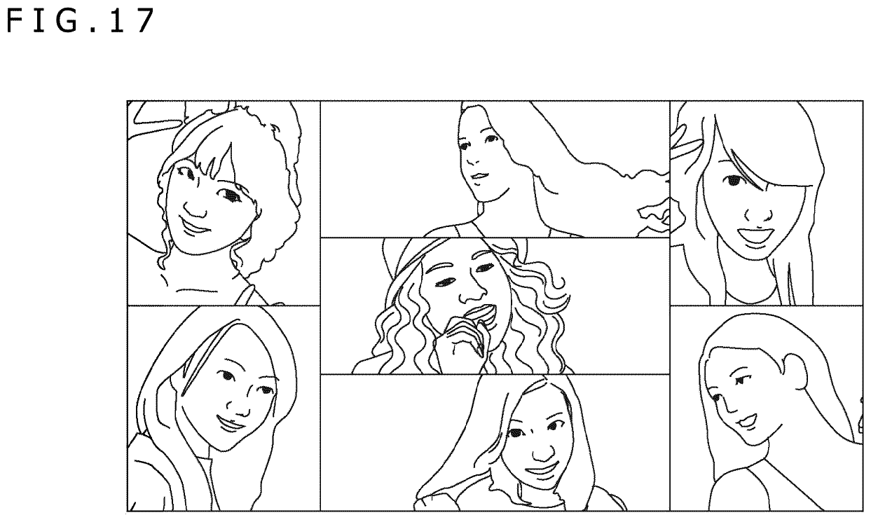

It should be noted that the video processing unit 14 can segment not only a rectangular cropped video, but also a substantially square cropped video and a horizontally-long rectangular cropped video, as depicted in FIG. 17, for tiling display.

### Example in Which an Effect of a Member Color is Added

In an idol group or the like, a color (member color) indicating a member is assigned to each member in some cases. The video processing unit 14 of the present technique can add (superimpose) an effect of a member color to a synthetic video in real time.

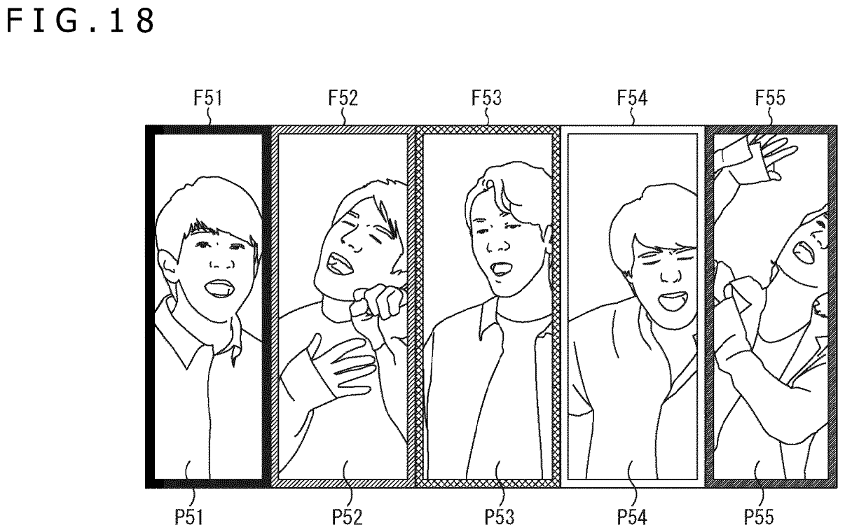

FIG. 18 is a diagram for depicting an example of a synthetic video to which an effect of a member color is added.

In the example of FIG. 18, a frame F51 of the member color of a performer P51 is added so as to surround a cropped video in which the performer P51 appears, and a frame F52 of the member color of a performer P52 is added so as to surround a cropped video in which the performer P52 appears. A frame F53 of the member color of a performer P53 is added so as to surround a cropped video in which the performer P53 appears, and a frame F54 of the member color of a performer P54 is added so as to surround a cropped video in which the performer P54 appears. A frame F55 of the member color of a performer P55 is added so as to surround a cropped video in which the performer P55 appears.

The video processing unit 14 can identify the member color of the person appearing in the cropped video by recognizing the person appearing in the camera video, and can add an effect according to the member color to the vicinity of the cropped video in real time.

Conventionally, an effect has been added from the past by preparing a CG in advance and inserting a cropped video segmented from a designated camera video into the CG. In this case, in order to associate a member with the CG of the member color, the arrangement order of the cropped videos in which the respective members appear is constrained. In addition, in order to associate the arrangement order of the cropped videos with the arrangement order of the performers on the stage, it has been impossible for the performers to change the arrangement order on the stage.

Even if the performers change their arrangement order on the stage, the video processing unit 14 of the present technique recognizes the performers appearing in the camera videos (cropped videos), so that the cropped videos are arranged in the order associated with the arrangement order of the performers on the stage, and effects associated with the members appearing in the cropped videos can be added. For example, as the effects associated with the members, the effects of the member colors are added to the cropped videos. Thus, the performers are released from the constraint of the standing positions. In addition, instead of displaying the cropped videos segmented from the designated camera videos, it is possible to display the cropped videos segmented from the camera videos in which, for example, the performers appear in good appearance.

### Example of a Case Where Recognition of the Face of a Performer has Failed

Since illumination environments change very drastically in a live venue, there is a case where face tracking (recognition) fails with an ordinary visible light camera. In addition, there is a case where, since a performer moves violently in a dance, for example, his/her hands overlap in front of his/her face, and face tracking fails. In the case where face recognition has failed, there is a possibility that cropped videos to be synthesized corresponding to some members cannot be obtained.

In the case where cropped videos to be synthesized corresponding to some members have not been able to be obtained, the video processing unit 14 does not output, for example, a synthetic video itself. In the video console, there is a case where a person in charge of creating a synthetic video and a person in charge of pressing a button for outputting the final video are separated. In this case, it is necessary to inform the person in charge of outputting the final video of whether or not all the members appear in the synthetic video. At present, the person in charge of outputting the final video visually confirms the number of members appearing in the final video (synthetic video). For example, by lighting a tally lamp or the like, it is possible to inform of whether or not the cropped videos to be synthesized corresponding to all the members have been acquired. For example, in the case where only cropped videos to be synthesized corresponding to four members among five members have been obtained, it is informed that the cropped videos to be synthesized corresponding to all the members have failed to be obtained by lighting an LED of a tally lamp or the like in red. In the case where the cropped videos to be synthesized corresponding to the five members have been obtained, it is informed that the cropped videos to be synthesized corresponding to all the members have succeeded to be obtained by lighting an LED of a tally lamp or the like in green. The person in charge of outputting the final video can reduce broadcasting accidents by reconfirming the final video (synthetic video).

In addition, in the case where the cropped videos to be synthesized corresponding to some members have not been able to be obtained, the video processing unit 14 can buffer a plurality of frames of camera videos at the past time, and can adopt cropped videos segmented from the plurality of frames as the cropped videos to be synthesized.

In the case where the face recognition has failed, the video processing unit 14 can recognize, for example, position information of the joints of the performer, and can identify the performer appearing in the camera video on the basis of the position information of the joints. For example, the performer can be identified by comparing the height estimated on the basis of the position information of the joints with the height of the performer.

The position information of the joints of the performer at the time when the performer can be identified by the face recognition may be buffered, and the performer may be identified on the basis of time-series changes of the position of the joints.

It should be noted that, for example, in the case where some members are not on the stage and cannot be photographed (or recognized), the video processing unit 14 can also segment cropped videos from camera videos obtained by photographing the members previously.

### Example in Which the Face of a Performer is Recognized by Using a Non-Visible Light Camera

Since illumination environments change very drastically in a live venue, there is a case where face tracking fails with an ordinary visible light camera in some cases. The video processing unit 14 of the present technique can recognize, for example, the face of a performer appearing in a camera video obtained by a non-visible light camera such as an IR (Infrared) camera or an SWIR (Short Wavelength Infrared) camera.

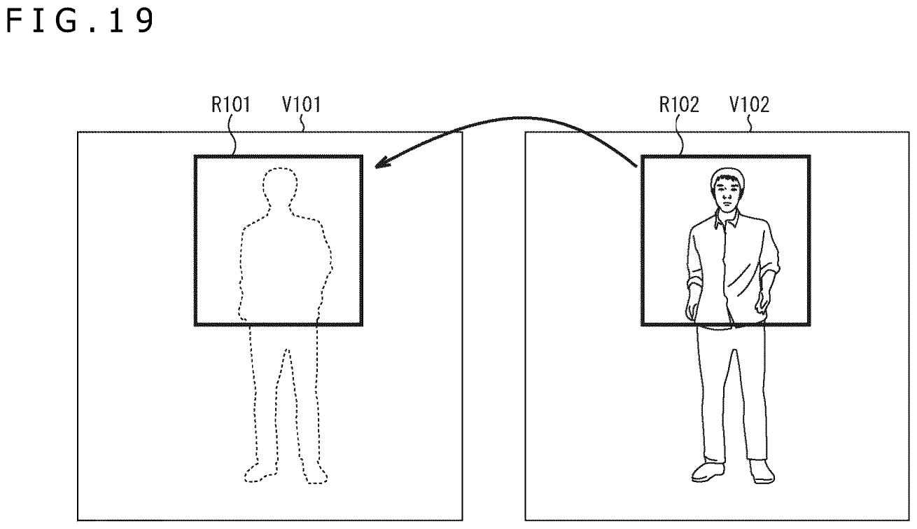

FIG. 19 is a diagram for depicting an example of recognizing the face of a performer appearing in a camera video of a non-visible light camera.

The video processing unit 14 recognizes the face of a performer appearing in both a camera video V101 photographed by a visible light camera depicted on the left side of FIG. 19 and a camera video V102 photographed by a non-visible light camera depicted on the right side of FIG. 19.

For example, in the case where the visible light camera is exposed to strong light, it becomes difficult to extract feature points of the face of the performer appearing in the camera video V101, and face recognition fails in some cases. Even in this case, the video processing unit 14 can identify the performer on the basis of the feature points of the face of the performer appearing in the camera video V102.

The positional relation between the visible light camera and the non-visible light camera (infrared ray or the like) is known by camera calibration. Since the positional relation between the visible light camera and the non-visible light camera is known, the video processing unit 14 can refer to a region on the camera video V101 corresponding to a region on the camera video V102.

In the case where it is difficult to extract the feature points of the face of the performer appearing in the camera video V101, the video processing unit 14 extracts the feature points of the face of the performer appearing in the camera video V102, and adjusts the range of a segmented region R102 on the camera video V102 on the basis of the feature points. Thereafter, as indicated by an arrow in FIG. 19, the video processing unit 14 refers to a segmented region R101 on the camera video V101 corresponding to the segmented region R102 on the camera video V102. By segmenting the segmented region R101 on the camera video V101, the video processing unit 14 can segment a cropped video equivalent to the cropped video segmented on the basis of the feature points of the face appearing in the camera video V101.

It should be noted that the video processing unit 14 can extract the feature points of the face of the performer appearing in the camera video V102 and can refer to the feature points on the camera video V101 corresponding to the feature points on the camera video V102.

As described above, the video processing unit 14 can prevent a failure in recognition of the face by recognizing the face of the performer appearing in both the camera video V101 and the camera video V102.

If the non-visible light camera synchronizes with the visible light camera, the non-visible light camera may be a camera having the same optical axis as the optical axis of the visible light camera, or a camera arranged in stereo with the visible light camera. The resolution and angle of view of the non-visible light camera do not matter. A bandpass filter may be applied to the non-visible light camera such that a region of skin can be easily recognized.

### Configuration Example of Computer

The above-described series of processing can be executed by hardware, or can be executed by software. In the case of executing the series of processing by software, a program configuring the software is installed from a program recording medium into a computer incorporated in dedicated hardware, a general-purpose personal computer, or the like.

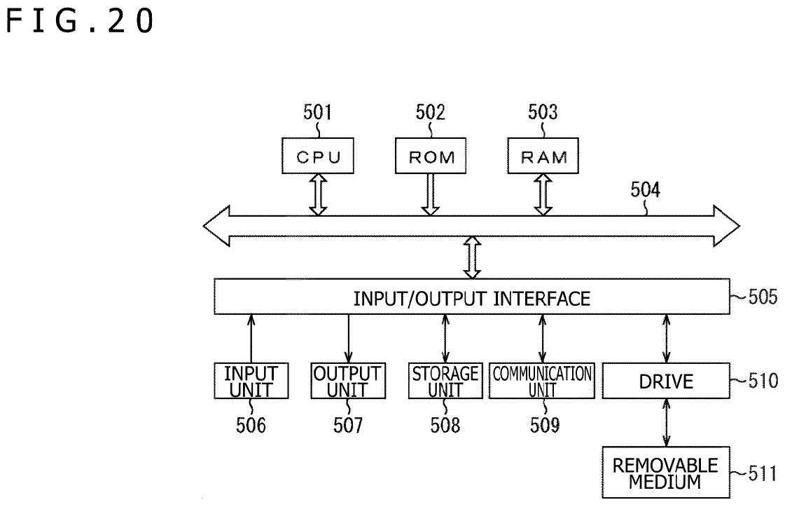

FIG. 20 is a block diagram for depicting a configuration example of hardware of a computer that executes the above-described series of processing by a program.

A CPU (Central Processing Unit) 501, a ROM (Read Only Memory) 502, and a RAM (Random Access Memory) 503 are connected to each other by a bus 504.

An input/output interface 505 is further connected to the bus 504. An input unit 506 including a keyboard, a mouse, and the like, and an output unit 507 including a display, a speaker, and the like are connected to the input/output interface 505. In addition, a storage unit 508 including a hard disk and a nonvolatile memory, a communication unit 509 including a network interface and the like, and a drive 510 for driving a removable medium 511 are connected to the input/output interface 505.

In the computer configured as described above, the CPU 501 loads and executes, for example, a program stored in the storage unit 508 into the RAM 503 via the input/output interface 505 and the bus 504, thereby performing the above-described series of processing.

The program executed by the CPU 501 is installed in the storage unit 508, for example, by being recorded in the removable medium 511, or by being provided via a wired or wireless transmission medium such as a local area network, the Internet, or digital broadcasting.

The program executed by the computer may be a program whose processing is performed in time series along the order described in the specification, or may be a program whose processing is performed in parallel or at a necessary timing such as when a call is made.

It should be noted that, in the specification, a system means a set of a plurality of constitutional elements (devices, modules (components), and the like), and it does not matter whether or not all the constitutional elements are in the same housing. Thus, both a plurality of devices housed in separated housings and connected to each other via a network and one device in which a plurality of modules is housed in one housing are systems.

It should be noted that the effects described in the specification are only examples and are not limited, and there may be other effects.

The embodiment of the present technique is not limited to the above-described embodiment, and various changes can be made without departing from the gist of the present technique.

For example, the present technique can adopt a cloud computing configuration in which one function is shared and jointly processed by a plurality of devices via a network.

In addition, each of the steps described in the above flowcharts can be shared and executed by a plurality of devices, in addition to execution by one device.

Further, in the case where a step includes a plurality of processes, the plurality of processes included in the step can be shared and executed by a plurality of devices, in addition to execution by one device.

### Example of Combination of Configurations

The present technique can adopt the following configurations.

(1)

A video processing device including:
an extraction unit that extracts, from a camera video obtained by photographing at least one of a plurality of persons, feature information indicating features of the person;
a segmentation unit that segments a cropped video for each person from the camera video on the basis of the feature information;
a recognition unit that recognizes the person appearing in the camera video; and
an arrangement control unit that arranges a plurality of the cropped videos on the basis of a recognition result of the person.
   (2)

The video processing device according to (1) above, in which
the segmentation unit adjusts, on the basis of the feature information, a range of a segmented region in the camera video from which the cropped video is segmented.
   (3)

The video processing device according to (2) above, in which
the segmentation unit adjusts the range of the segmented region on the basis of at least any one of a size, aspect ratio, and resolution of a display unit on which the cropped video is displayed.
   (4)

The video processing device according to (2) or (3) above, in which
the range of the segmented region is adjusted on the basis of the number of cropped videos displayed on a display unit.
   (5)

The video processing device according to any one of (1) to (4) above, in which
the segmentation unit adjusts a size of the cropped video on the basis of the feature information.
   (6)

The video processing device according to any one of (1) to (5) above, in which
the feature information includes at least any one of feature points of a face of the person, a bounding box surrounding the face of the person, and position information of joints of the person.
   (7)

The video processing device according to any one of (1) to (6) above, in which
the arrangement control unit arranges the cropped video at a position assigned to the person.
   (8)

The video processing device according to any one of (1) to (6) above, in which
the arrangement control unit arranges a plurality of the cropped videos on the basis of an arrangement order of the persons on the camera video obtained by photographing a plurality of the persons.
   (9)

The video processing device according to any one of (1) to (8) above, in which
the arrangement control unit selects the cropped video to be arranged on the basis of at least any one of a resolution of a region in the cropped video in which the person appears and an orientation of the person on the cropped video.
   (10)

The video processing device according to any one of (1) to (9) above, in which
the arrangement control unit adds an effect associated with the person recognized by the recognition unit to the cropped video in which the person appears.
   (11)

The video processing device according to (10) above, in which
a color of the effect indicates the person recognized by the recognition unit.
   (12)

The video processing device according to any one of (1) to (11) above, in which
the recognition unit recognizes a face of the person.
   (13)

The video processing device according to (12) above, in which,
in a case where the recognition unit has failed to recognize the face, the arrangement control unit arranges the cropped video segmented from the camera video obtained by photographing the person previously.
   (14)

The video processing device according to (12) or (13) above, in which,
in a case where the recognition unit has failed to recognize the face, the recognition unit recognizes the person on the basis of position information of joints of the person.
   (15)

The video processing device according to any one of (1) to (14) above, in which
the segmentation unit segments the cropped video from the camera video obtained by a visible light camera, and
the recognition unit recognizes the person appearing in the camera video obtained by a non-visible light camera.
   (16)

The video processing device according to any one of (1) to (15) above, in which
the segmentation unit segments the cropped video from the camera video obtained by a visible light camera, and
the extraction unit extracts the feature information of the person appearing in the camera video obtained by a non-visible light camera.
   (17)

The video processing device according to any one of (1) to (16) above, further including:
a synthesis unit that synthesizes a plurality of the cropped videos so as to be arranged side by side on a two-dimensional plane.
   (18)

The video processing device according to any one of (1) to (17) above, in which
the recognition unit recognizes the person appearing in the camera video by using a recognizer that has learned in advance the feature information of the person who possibly appears in the camera video.
   (19)

A video processing method comprising:
by a video processing device
   extracting, from a camera video obtained by photographing at least one of a plurality of persons, feature information indicating features of the person,
   segmenting a cropped video for each person from the camera video on the basis of the feature information,
   recognizing the person appearing in the camera video, and
   arranging a plurality of the cropped videos on the basis of a recognition result of the person.
      (20)

A program that causes a computer to execute processing of:
extracting, from a camera video obtained by photographing at least one of a plurality of persons, feature information indicating features of the person;
segmenting a cropped video for each person from the camera video on the basis of the feature information;
recognizing the person appearing in the camera video; and
arranging a plurality of the cropped videos on the basis of a recognition result of the person.

### REFERENCE SIGNS LIST

11-1: Bird's eye camera
11-2 to 11-N: Tour camera
12: SDI router
13: Camera switcher
14: Video processing unit
15: Final video switcher
16: Display unit
31: Feature information extraction unit
32: Segmentation unit
33: Size adjustment unit
34: Synthesis unit
51: Camera video analysis unit
52: Performer identification unit
53: Arrangement control unit

1. A video processing device comprising:
an extraction unit that extracts, from a camera video obtained by photographing at least one of a plurality of persons, feature information indicating features of the person;
a segmentation unit that segments a cropped video for each person from the camera video on a basis of the feature information;
a recognition unit that recognizes the person appearing in the camera video; and
an arrangement control unit that arranges a plurality of the cropped videos on a basis of a recognition result of the person.

2. The video processing device according to claim 1, wherein
the segmentation unit adjusts, on the basis of the feature information, a range of a segmented region in the camera video from which the cropped video is segmented.

3. The video processing device according to claim 2, wherein
the segmentation unit adjusts the range of the segmented region on a basis of at least any one of a size, aspect ratio, and resolution of a display unit on which the cropped video is displayed.

4. The video processing device according to claim 2, wherein
the range of the segmented region is adjusted on a basis of the number of cropped videos displayed on a display unit.

5. The video processing device according to claim 1, wherein
the segmentation unit adjusts a size of the cropped video on the basis of the feature information.

6. The video processing device according to claim 1, wherein
the feature information includes at least any one of feature points of a face of the person, a bounding box surrounding the face of the person, and position information of joints of the person.

7. The video processing device according to claim 1, wherein
the arrangement control unit arranges the cropped video at a position assigned to the person.

8. The video processing device according to claim 1, wherein
the arrangement control unit arranges a plurality of the cropped videos on a basis of an arrangement order of the persons on the camera video obtained by photographing a plurality of the persons.

9. The video processing device according to claim 1, wherein
the arrangement control unit selects the cropped video to be arranged on a basis of at least any one of a resolution of a region in the cropped video in which the person appears and an orientation of the person on the cropped video.

10. The video processing device according to claim 1, wherein
the arrangement control unit adds an effect associated with the person recognized by the recognition unit to the cropped video in which the person appears.

11. The video processing device according to claim 10, wherein
a color of the effect indicates the person recognized by the recognition unit.

12. The video processing device according to claim 1, wherein
the recognition unit recognizes a face of the person.

13. The video processing device according to claim 12, wherein,
in a case where the recognition unit has failed to recognize the face, the arrangement control unit arranges the cropped video segmented from the camera video obtained by photographing the person previously.

14. The video processing device according to claim 12, wherein,
in a case where the recognition unit has failed to recognize the face, the recognition unit recognizes the person on a basis of position information of joints of the person.

15. The video processing device according to claim 1, wherein
the segmentation unit segments the cropped video from the camera video obtained by a visible light camera, and
the recognition unit recognizes the person appearing in the camera video obtained by a non-visible light camera.

16. The video processing device according to claim 1, wherein
the segmentation unit segments the cropped video from the camera video obtained by a visible light camera, and
the extraction unit extracts the feature information of the person appearing in the camera video obtained by a non-visible light camera.

17. The video processing device according to claim 1, further comprising:
a synthesis unit that synthesizes a plurality of the cropped videos so as to be arranged side by side on a two-dimensional plane.

18. The video processing device according to claim 1, wherein
the recognition unit recognizes the person appearing in the camera video by using a recognizer that has learned in advance the feature information of the person who possibly appears in the camera video.

19. A video processing method comprising:
by a video processing device
extracting, from a camera video obtained by photographing at least one of a plurality of persons, feature information indicating features of the person,
segmenting a cropped video for each person from the camera video on a basis of the feature information,
recognizing the person appearing in the camera video, and
arranging a plurality of the cropped videos on a basis of a recognition result of the person.

20. A program that causes a computer to execute processing of:
extracting, from a camera video obtained by photographing at least one of a plurality of persons, feature information indicating features of the person;
segmenting a cropped video for each person from the camera video on a basis of the feature information;
recognizing the person appearing in the camera arranging a plurality of the cropped videos on a basis of a recognition result of the person.
